(19) United States
(12) Patent Application Publication
(10) Pub. No.: US 2024/0047794 A1
(43) Pub. Date: Feb. 8, 2024

(54) CASING FOR POWER STORAGE DEVICE, AND POWER STORAGE DEVICE

(71) Applicant: Resonac Packaging Corporation, Hikone-shi (JP)

(72) Inventors: Daisuke NAKAJIMA, Hikone-shi (JP); Yuuji MINAMIBORI, Hikone-shi (JP)

(73) Assignee: Resonac Packaging Corporation, Hikone-shi (JP)

(21) Appl. No.: 18/267,096

(22) PCT Filed: Dec. 13, 2021
(86) PCT No.: PCT/JP2021/045743

§ 371 Date: Jun. 14, 2023

(30) Foreign Application Priority Data
Dec. 16, 2020 (JP) 2020-208209
Nov. 17, 2021 (JP) 2021-186839

(51) Int. Cl. H01M 50/136; H01M 50/126; H01M 50/121; H01M 50/103; H01G 11/80

(52) U.S. Cl. CPC H01M 50/136; H01M 50/126; H01M 50/121; H01M 50/103; H01G 11/80

(57) ABSTRACT

Provided is a packaging material for a power storage device excellent in workability and piercing resistance. The present invention relates to a packaging material for a power storage device, including a base material layer 51, a barrier layer 52 laminated on an inner side of the base material layer 51, and a sealant layer 53 laminated an inner side of the barrier layer 52. The base material layer 51 is formed of a polyamide film and is 2.0% to 5.0% both in hot water shrinkage in a transverse direction (TD) and a machine direction (MD), 1.5% or less in a difference between the hot water shrinkage in the TD and the MD, 1.5 GPa to 3 GPa in elastic modulus in both the TD and the MD, and 320 MPa or more in at least one of breaking strengths in the TD and the MD.

### TECHNICAL FIELD

The present invention relates to a packaging material for a power storage device, such as, e.g., a battery and a capacitor, used in a mobile terminal including a smartphone, a tablet computer (tablet PC) and the like, and a packaging material for a power storage device, such as, e.g., a battery and a capacitor, used in a hybrid vehicle and an electric vehicle. The present invention also relates to a power storage device.

### BACKGROUND ART

A power storage device is used as an energy source for moving machines, such as, e.g., an electric vehicle and a hybrid vehicle, and also used as an energy source for a mobile device, such as, e.g., a power tool and a portable terminal. Such a power storage device is required to be reduced in weight and miniaturized in size to facilitate transportation and portability. For this reason, as a casing for a power storage device, conventionally, a metal can has been mainly used, but in recent years, a metallic laminate material (packaging material) composed of a base layer, a barrier layer (metal foil layer), and a sealant layer as a basic configuration is often used.

In such a mobile or portable type non-stational storage device, unlike a stationary power storage device, the packaging material is highly likely to be damaged by vibrations, external pressures, or the like, and therefore the packaging material is required to have the same mechanical strength as a metallic can, particularly required to have piercing resistance.

Conventionally, in a packaging material, an aluminum foil is used for a barrier layer, but it was difficult to obtain satisfactory piercing resistance by an ordinary aluminum laminate material.

Under the circumstance, in the power storage device described in Patent Document 1 listed below, as a packaging material, it has been tried to improve the piercing resistance by using a metallic laminate material (stainless steel laminate material) formed of a stainless-steel foil (SUS foil) having higher rigidity than an aluminum foil as a barrier layer.

### PRIOR ART DOCUMENT

### Patent Document

Patent Document 1: Japanese Unexamined Patent Application Publication No. 2020-161362

### SUMMARY OF THE INVENTION

### Problems to be Solved by the Invention

However, since a stainless-steel foil is high in rigidity, in a case where a stainless-steel laminate material is used as a packaging material for a power storage device, the formability (workability) of the packaging material deteriorates, which may cause a decrease in dimensional accuracy and a decrease in production efficiency.

Preferred embodiments of the present invention have been made in view of the above-described and/or other problems in the related art. Preferred embodiments of the present invention can significantly improve upon existing methods and/or devices.

An object of the present invention disclosure is to provide a packaging material for a power storage device and a power storage device excellent in formability and piercing resistance.

Other objects and advantages of the present invention will be apparent from the following preferred embodiments.

### Means for Solving the Problem

In order to solve the above-described problem, the present invention includes the following means.

[1] A packaging material for a power storage device, comprising:
a base material layer;
a barrier layer laminated on an inner side of the base material layer; and
a sealant layer laminated an inner side of the barrier layer,
wherein the base material layer is formed of a polyamide film,
wherein the base material layer is 2.0% to 5.0% in hot water shrinkage in both a transverse direction (TD) and a machine direction (MD),
wherein the base material layer is 1.5% or less in a difference between the hot water shrinkage in the transverse direction (TD) and the hot water shrinkage in the machine direction (MD),
wherein the base material layer is 1.5 GPa to 3 GPa in elastic modulus in both the transverse direction (TD) and the machine direction (MD), and
wherein the base material layer is 320 MPa or more in at least one of a breaking strength in the transverse direction (TD) and a breaking strength in the machine direction (MD).

[2] The packaging material for a power storage device as recited in the above-described Item [1],
wherein the base material layer is 2.5% to 4.5% in both the hot water shrinkage in the transverse direction (TD) and the hot water shrinkage in the machine direction (MD).

[3] The packaging material for a power storage device as recited in the above-described Item [1] or [2],
wherein the base material layer is 1.2% or less in a difference between the hot water shrinkage in the transverse direction (TD) and the hot water shrinkage in the machine direction (MD).

[4] The packaging material for a power storage device as recited in any one of the above-described Items [1] to [3],
wherein the base material layer is 2.0 GPa to 2.5 GPa in both elastic modulus in the transverse direction (TD) and elastic modulus in the machine direction (MD).

[5] The packaging material for a power storage device as recited in any one of the above-described Items [1] to [4],
wherein the base material layer is 400 MPa or less in at least one of a breaking strength in the transverse direction (TD) and a breaking strength in the machine direction (MD).

[6] A power storage device comprising:
a power storage device main body; and
the packaging material as recited in any one of the above-described Items [1] to [5],
wherein the power storage device main body is packaged with the packaging material.

### Effects of the Invention

According to the packaging material for a power storage device of the above-described invention [1], since the base material layer arranged on the outer surface side is constituted by a specific polyamide film, it has moderate flexibility and can maintain a desired strength. Furthermore, the base material layer is small in the difference between the hot water shrinkage in the machine direction (MD) and the hot water shrinkage in the transverse direction (TD), and thus can efficiently disperse the force from the external pressure. Moreover, since the base material layer is provided with a predetermined breaking strength, it is possible to reliably maintain an adequate strength. Therefore, the packaging material for a power storage device of the present invention is excellent in formability and has adequate piercing resistance.

According to the packaging material for a power storage device of the above-described inventions [2] to [5], the above-described advantages can be obtained more assuredly.

According to the power storage device of the invention [6], since it is manufactured using the above-described packaging material of the invention, the same advantages as those described above can be obtained.

### BRIEF DESCRIPTION OF THE DRAWINGS

FIG. 1 is a cross-sectional side view showing a power storage device according to one embodiment of the present intention.

FIG. 2 is a perspective view showing a power storage device according to one embodiment of the present invention in an exploded manner.

FIG. 3 is a schematic cross-sectional view schematically showing a packaging material of a power storage device according to one embodiment.

FIG. 4 is a schematic diagram for describing a machine direction (MD) and a transverse direction (TD) in a resin film.

### EMBODIMENTS FOR CARRYING OUT THE INVENTION

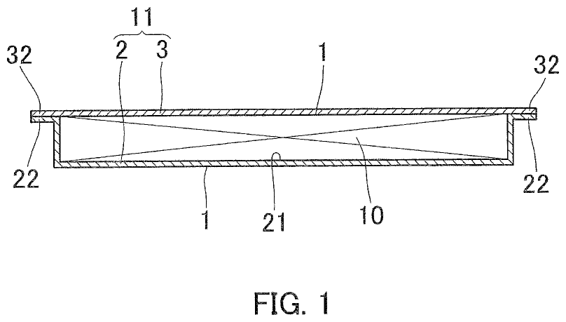

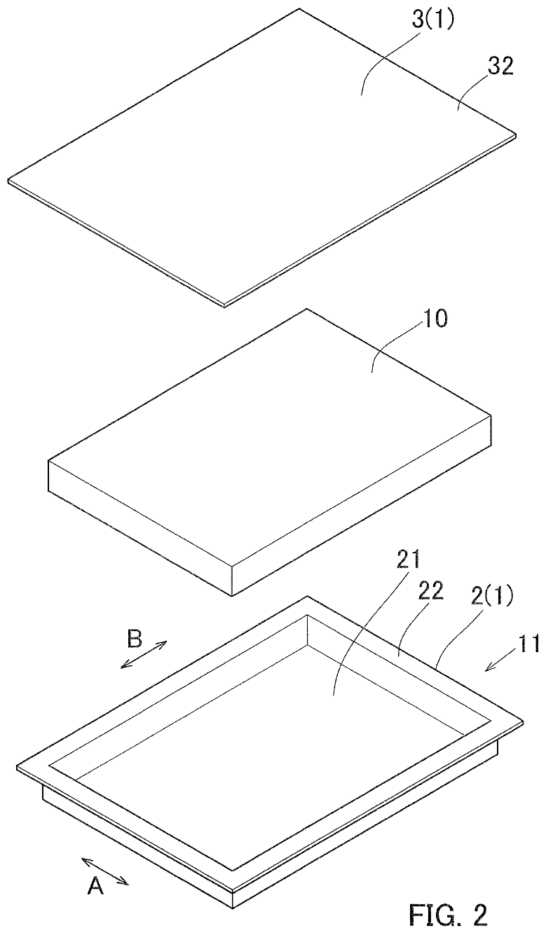

FIG. 1 is a cross-sectional side view showing a power storage device according to one embodiment of the present invention, and FIG. 2 is a perspective view showing a power storage device according to one embodiment of the present invention in an exploded manner.

As shown in both figures, the power storage device of this embodiment is provided with a casing (container) 11 as an outer package, and a power storage device main body 10, such as, e.g., an electrochemical device, accommodated in the casing 11.

The casing 11 is constituted by a tray member 2 having a rectangular shape in plan view and formed by a packaging material 1, and a cover member 3 having a rectangular shape in plan view and formed by a packaging material 1.

The tray member 2 is formed of a molded article obtained by molding a packaging material 1 using a method, such as, e.g., deep drawing. In the tray member 2, the entire intermediate region except for the outer peripheral edge portion is recessed downward to form a recessed portion 21 having a rectangular shape in plan view, and an outwardly protruded flange portion 22 is integrally formed on the outer periphery of the opening edge portion of the recessed portion 21.

Further, the cover member 3 is constituted by a packaging material 1 formed in a sheet-like shape. In the cover member 3, the outer peripheral edge portion is configured as a flange portion 32 corresponding to the flange portion 22 of the tray member 2.

The packaging material 1 as the tray member 2 and the cover member 3 is constituted by an outer packaging laminate, which is a laminate sheet or film with softness and flexibility.

The power storage device main body 10 is not particularly limited, and the examples thereof include a battery main body, and a capacitor main body. The power storage device main body 10 is formed into a shape corresponding to the recessed portion 21 of the tray member 2.

As will be described later, in a state in which a power storage device main body 10 is accommodated in the recessed portion 21, the cover member 3 is arranged on the tray member 2 to cover the recessed portion 21, and the flange portions 22 and 32 of the tray member 2 and the cover member 3 are thermally fused to each other, thereby forming a power storage device of this embodiment.

Although not shown in the drawings, one end (inner end) of a tab lead is connected to the power storage device main body 10, and the other end (outer end) thereof is arranged to be pulled out to the outside of the power storage device, so that electricity can be taken in and out of the power storage device main body 10 via the tab lead.

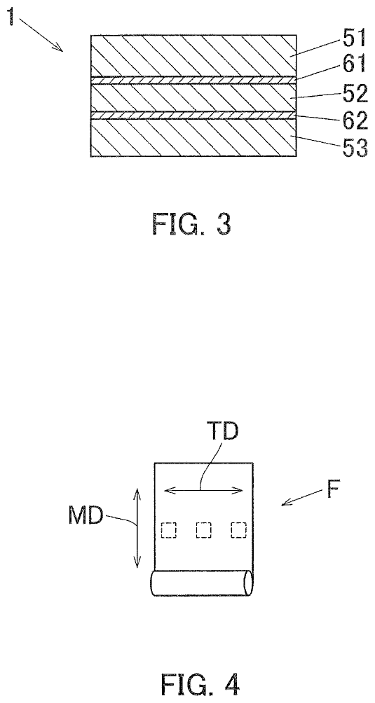

FIG. 3 is a schematic cross-sectional view schematically showing the basic configuration of the outer packaging laminate material constituting the packaging material 1 in this embodiment. As shown in the drawing, the packaging material 1 (laminate material) used in this embodiment is provided with a base material layer 51, a barrier layer (metal foil layer) 52 bonded to one surface (inner surface) of the base material layer 51 via an adhesive layer 61, and a sealant layer (heat-fusible resin layer) 53 bonded to one surface (inner surface) of the metal foil layer 52 via an adhesive layer 62.

In this embodiment, the base material layer 51 is constituted by a polyamide film.

As this polyamide film, a biaxially stretched film of 6 nylon, 6,6 nylon, MXD nylon, or the like is preferably used. As a method for producing the biaxially stretched film in this embodiment, it is preferable to use simultaneous stretching and sequential stretching.

In this embodiment, the base material layer 51 needs to adjust both the hot water shrinkage in the transverse direction (TD) and the hot water shrinkage in the machine direction (MD) to 2.0% to 5.0%, preferably 2.5% to 4.5%.

As shown in FIG. 4, the term “MD” refers to the molding direction (the flow direction of the resin) of a resin film F, and the term “TD” refers to a direction perpendicular to the MD.

Further, the hot water shrinkage denotes a dimensional change rate in a shrinkage direction (stretching direction) before and after immersion of a film (measurement target) in hot water at 100° C. for 5 minutes. For example, when the dimension of the shrinkage direction (MD or TD) before the hot water immersion is “X,” and the dimension of the shrinkage direction (MD or TD) after the hot water immersion is “Y,” the hot water shrinkage (%) in the shrinkage direction (MD or TD) is determined by a relational expression of {(X−Y)/X}×100.

Note that in the present invention, it is preferable to adopt an average value (average hot water shrinkage) of hot water shrinkage as the “hot water shrinkage” indicating a characteristic value of a polyamide film. In the present invention, the average hot water shrinkage is an average value of hot water shrinkage at three points, i.e., hot water shrinkage at two both end points and hot water shrinkage at one center point, with respect to one direction of the sheet (film) to be measured, as will be described later. However, depending on the size of the power storage device main body 10 in the present invention, it is possible to adopt hot water shrinkage (hydrothermal absorption rate at the reference position), which is not an average value measured at a certain point, as the “hot water shrinkage” indicating the property value of the polyamide film.

Since the hot water shrinkage in the transverse direction (TD) and in the machine direction (MD) in this embodiment is 2.0% or more, appropriate flexibility is provided, and good formability can be secured as the base material layer 51. Further, since the hot water shrinkage is 5.0% or less, excessive flexibility can be avoided as the base material layer 51, and a desired strength can be maintained.

Further, in this embodiment, it is necessary to adjust the difference between the hot water shrinkage of the base material layer 51 in the machine direction (MD) and the hot water shrinkage of the base material layer 51 in the transverse direction (TD) to 1.5% or less, preferably 1.2% or less. Specifically, when the average hot water shrinkage in the machine direction (MD) is “MDz” and the hot water shrinkage in the transverse direction (TD) is “TDz,” it is necessary to establish the relational expression |MDz−TDz|≤1.5%, preferably |MDz−TDz|≤1.2% or less.

That is, in this embodiment, since the difference between the hot water shrinkage in the transverse direction (TD) and the hot water shrinkage in the machine direction (MD) is adjusted to fall within the specified range, it is possible to efficiently disperse the force from the external pressure, and the desired strength can be assuredly maintained as the base material layer 51.

Further, in this embodiment, it is necessary to adjust the elastic modulus of the base material layer 51 in the machine direction (MD) and the elastic modulus of the base material layer 51 in the transverse direction (TD) to 1.5 GPa to 3 GPa, preferably 2.0 GPa to 2.5 GPa.

That is, in a case where the elastic modulus of the base material layer 51 in the transverse direction (TD) and the elastic modulus of the base material layer 51 in the machine direction (MD) are adjusted within the above-described specified range, it is possible to more assuredly maintain moderate flexibility and strength as the base material layer 51.

Further, in this embodiment, it is necessary to adjust at least one of the breaking strength of the base material layer 51 in the transverse direction (TD) and the breaking strength of the base material layer 51 in the machine direction (MD) to 320 MPa or more, preferably 400 MPa or less.

That is, in a case where the breaking strengths in the transverse direction (TD) and in the machine direction (MD) are adjusted within the above-described specified range, the desired strength can be more assuredly obtained as the base material layer 51.

By adopting a polyamide film having the above-described properties for the base material layer 51 as described above, it is possible to obtain a packaging material 1 having good formability and excellent piercing resistance.

Further, in this embodiment, the polyamide-resin content rate of the film constituting the base material layer 51 is adjusted to preferably 90 wt % to 100 wt %, more preferably 95 wt % to 100 wt %, particularly 98 wt % to 100 wt %.

Further, the number average molecular weight of the nylon as the polyamide film constituting the base material layer 51 in this embodiment is adjusted to preferably 15,000 to 30,000, more preferably 20,000 to 30,000, particularly 20,000 to 25,000.

That is, in a case where the number average molecular weight of the nylon as the base material layer 51 is 15,000 or more, the base material layer 51 becomes less likely to be torn. In a case where the molecular weight is 40,000 or less, the flexibility of the base material layer 51 can be maintained, resulting in hard-to-be-cracked.

Further, in this embodiment, the relative viscosity of the polyamide film as the base material layer 51 is preferably adjusted to 2.9 to 3.1. In other words, in a case where the relative viscosity is adjusted to fall within the above-specified range, the strength and flexibility can be more effectively imparted as the base material layer 51, and it is possible to assuredly obtain the packaging material 1 excellent in formability and high in piercing resistance.

In this embodiment, the piercing strength of the packaging material 1 is preferably within the range of 22 N to 30 N, more preferably 24 N to 30 N, and even more preferably 26 N to 30 N.

Further, in this embodiment, the thickness of the (polyamide film) as the base material layer 51 is preferably adjusted to 9 μm to 25 μm, more preferably 12 μm to 25 μm, and even more preferably 17 μm to 23 μm. The thickness error of the polyamide film is preferably adjusted to 1 μm or less.

Here, the distribution of the hot water shrinkage in the polyamide film of this embodiment will be described. First, in a square polyamide film, when the hot water shrinkage at three points on both sides and a center line in the machine direction (ND) is fixed-point hot water shrinkage, and the hot water shrinkage at three points on both side and a center line in the transverse direction (TD) is three points of the fixed-point hot water shrinkage, it is preferable to use a film in which the difference between the largest fixed-point hot water shrinkage and the smallest fixed-point hot water shrinkage out of a total of fixed-point hot water shrinkage at six points, i.e., the fixed-point hot water shrinkage at three points in the machine direction (MD) and the fixed-point hot water shrinkage at three points in the machine direction (MD).

Note that the average value of the fixed-point hot water shrinkage at three points in the machine direction (MD) corresponds to the average hot water shrinkage in the machine direction (MD), and the average value of the hot water shrinkage at the three points in the transverse direction (TD) corresponds to the average hot water shrinkage in the transverse direction (TD).

Here, the three regions indicated by the broken lines in FIG. 4 are all square regions of the same size of the polyamide film (base material layer 51). In a case where the square regions satisfy the above-described distribution condition of the hot water shrinkage, the deviation of the flexibility is suppressed over the entire area of the base material layer 51. For this reason, even if external stress is applied, the external stress is dispersed to the entirety of the base material layer 51, resulting in hard-to-be-cracked, which in turn can assuredly improve the strength.

In this embodiment, the base material layer 51 is formed of a polyamide film, but other layers may be laminated on the base material layer 51.

For example, a biaxially stretched polyamide film (6 nylon, 6,6 nylon, MXD nylon, etc.), a biaxially stretched polyester film (polybutylene terephthalate (PBT), polyethylene terephthalate (PET), polyethylene naphthalate (PEN), etc.) may be laminated on the base material layer 51.

In the base material layer 51, a resin having a melting point higher by 10° C. or more, preferably 20° C. or more, than that of all resins constituting the sealant layer 53 is preferably employed. That is, in a case where this configuration is adopted, it is possible to avoid the adverse effect of heat on the base material layer 51 when thermally fusing the sealant layer 53.

In this embodiment, it is preferable to form an easily adhesive layer by subjecting the bonding surface of the base material layer 51 to be bonded to the barrier layer 52 to an easy adhesion treatment to form an easily adhesive layer. That is, an easily adhesive layer is formed by applying an aqueous-based emulsion (water-based emulsion) of one or more resins selected from the group consisting of an epoxy resin, a urethane resin, an acrylic ester resin, a methacrylic ester resin, a polyester resin, and a polyethyleneimine resin to the bonding surface and drying it. The formation amount of this easily adhesive layer is preferably set to 0.01 g/m² to 0.5 g/m².

By applying an easy adhesion treatment to the base material layer 51 as described above, it is possible to sufficiently secure adhesive strength as the barrier layer 52.

The barrier layer 52 is preferably formed of a metal foil layer, such as, e.g., an aluminum foil, a copper foil, a stainless-steel foil, a titanium-foil, a nickel-foil, or a cladding material.

The thickness of the barrier layer 52 is preferably set to 20 μm to 100 μm. Further, the barrier layer 52 may be subjected to a surface preparation (surface treatment), such as, e.g., a chemical conversion treatment, to prevent corrosion of the barrier layer 52 or improve the bonding properties of the barrier layer 52 to a resin.

As the sealant layer 53, it is preferable to use a non-stretched film of a polyolefin-based resin, such as, e.g., polypropylene and polyethylene.

The thickness of this sealant layer 53 is preferably set to 20 μm to 100 μm.

As the adhesive layer 61 for bonding the base material layer 51 and the barrier layer 52, an adhesive layer made of a two-part curing type adhesive agent can be used. For example, it is preferable to use a two-part curing type adhesive agent configured by a first liquid composed of one or two or more kinds of polyols selected from the group consisting of polyurethane-based polyol, polyester-based polyol, polyether-based polyol, and polyester urethane-based polyol, and a second liquid (curing agent) composed of isocyanate.

The thickness of the adhesive layer 61 is preferably set to 2 μm to 5 μm.

As the adhesive layer 62 for bonding the barrier layer 52 and the sealant layer 53, it is preferable to use an adhesive containing one type or more of a polyurethane-based resin, an acryl-based resin, an epoxy-based resin, a polyolefin-based resin, an elastomer-based resin, a fluorine-based resin, an acid-modified polypropylene resin, or the like. In particular, it is more preferable to use an adhesive agent made of a polyurethane-composite resin having acid-modified polyolefin as a main agent.

The thickness of the adhesive layer 62 is preferably set to 2 μm to 5 μm.

As described above, in this embodiment, the tray member 2 and the cover member 3 are each configured by the packaging material 1 having the above-described configuration.

In forming the recessed portion 21 of the tray member 2, when the short-side direction of the tray member 2, which is a molded article, is made to be parallel to a portion of the packaging material 1 in the polyamide film as the base material layer of the packaging material 1 higher in the hot water shrinkage, good formability can be obtained. For example, in a case where the hot water shrinkage of the base material layer of the packaging material 1 in the machine direction MD is higher than the hot water shrinkage of the base material layer in the transverse direction TD, in forming the tray member 2 as shown in FIG. 2, good formability can be obtained by forming the tray member 2 by aligning the short-side direction with the machine direction MD of the base material layer and aligning the long-side direction B with the transverse direction TD of the base material layer.

In this embodiment, when assembling the tray member 2, the cover member 3, and the power storage device main body 10, in a state in which the power storage device main body 10 is accommodated in the recessed portion 21 of the tray member 2, the cover member 3 is arranged to close the opening of the recessed portion 21 of the tray member 2. Thus, a power storage device in a temporarily assembled state is manufactured.

The flange portion 22 of the tray member 2 and the flange portion 32 of the cover member 3 in a temporarily assembled state are heated while being pinched, whereby the sealant layers 53 of the flange portions 22 and 32 are thermally fused (thermally bonded) to each other. In this way, a power storage device in which the power storage device main body 10 is sealed in the casing 11 configured by the tray member 2 and the cover member 3 is manufactured.

In this power storage device, it is possible to maintain a desired casing with moderate flexibility since the base material layer 51 arranged on the outer peripheral surface of the packaging material 1 in the casing 11 is configured by a polyamide film in which the hot water shrinkage and the elastic modulus in the machine direction MD and the transverse direction TD are set to fall within specified ranges. Further, the base material layer 51 can efficiently disperse the force from an external pressure because the difference between the hot water shrinkage in the machine direction MD and the hot water shrinkage in the transverse direction TD are set to fall within a predetermined range. Moreover, since the base material layer 51 has a predetermined breaking strength, it is possible to maintain an adequate strength reliably. Therefore, it is possible to provide a high-quality power storage device because the packaging material 1 of the power storage device according to this embodiment is excellent in formability, excellent in dimensional accuracy, excellent in dimensional stability, and sufficient in piercing resistance.

Further, the bonding surface of the base material layer 51 to be bonded to the barrier layer 52 is subjected to an easy adhesion treatment, and therefore, both the layers 51 and 52 can be bonded with sufficient strength, and the base material layer 51 and the barrier layer 52 can be integrated. Therefore, since the base material layer 51 is arranged in a stabilized manner, it is possible to further improve the formability and the piercing resistance.

Note that in the embodiment described above, although a case in which the sheet-like packaging material 1 is used for the cover member 3 is described, the present invention is not limited thereto. In the present invention, the cover member 3 may be subjected to molding processing. For example, the cover member may be constituted by a molded article having a hat-shaped cross-section in which the central portion is recessed (bulged) upward, and the outer peripheral edge portion may be integrally joined to the outer peripheral edge portion of the tray member in a state in which the hat-shaped cover member covers the tray member as described above from above. Further, in the present invention, a casing may be formed by arranging two sheet-like non-molded packaging materials 1 to sandwich a power storage device main body therebetween and thermally fusing the outer peripheral edge portions thereof.

Further, in the above-described embodiment, an example is shown in which a casing is formed using two packaging materials (outer packaging laminate materials), but the present invention is not limited thereto. In the present invention, the number of packaging materials forming the casing is not limited, and may be one or three or more.

Further, in this embodiment, a packaging material having a three-layer structure is used, but the present invention is not limited thereto. In the present invention, a packaging material having a four-layer or more structure may be used. For example, it may be configured such that another layer is interposed between the base material layer and the barrier layer, or another layer is interposed between the barrier layer and the sealant layer, to thereby form a four-layer or more structure.

### EXAMPLES

In this example, packaging materials 1 for a power storage device according to Examples 1 to 7 and packaging materials 1 and 2 for a power storage device according to Comparative Examples 1 to 3 deviating from the present invention were prepared, and various evaluations were performed.

### Example 1

A barrier layer 52 with a chemical conversion coating film formed on both surfaces was prepared by applying a chemical conversion treatment solution consisting of polyacrylic acid, trivalent chromium compound, water, and alcohol on both surfaces of an aluminum foil (aluminum foil of A8079 defined by JIS H4160) having a thickness of 35 μm as a barrier layer 52, and drying at 150° C. The chrome adhesion by the chemical conversion coating film was 5 mg/m² on one side.

Next, a biaxially stretched 6 nylon (ONy) film having a thickness of 20 μm as a base material layer 51 was bonded to one surface (outer surface) of the chemically treated aluminum foil (barrier layer 52) via a two-part curing type urethane-based adhesive agent (adhesive layer 61) by dry lamination. The details of the nylon film will be described later.

Next, a non-stretched polypropylene (CPP) film having a 40 μm thickness as a sealant layer 53 was dry-laminated on the other surface (inner surface) of the aluminum foil (barrier layer 52) after the dry lamination via a two-part curing type maleic acid-modified polypropylene adhesive agent (adhesive layer 62) by being pinched by a rubber nip roll and a laminate roll heated to 100° C. to be pressure-bonded. Thereafter, it was aged (heated) at 40° C. for 10 days to thereby obtain a packaging material 1 for a power storage device.

Note that the biaxially stretched 6 nylon film as a base material layer was prepared by stretching a nylon film extruded by a T-die method by a tenter method. Further, both surfaces of the nylon film as the base material layer were subjected to a corona treatment. Further, a coating liquid containing an acrylic ester resin and an epoxy resin was applied to one surface (inner surface) of the nylon-film as needed, and dried to form an easily adhesive layer (0.05 μm) (easy adhesion processing). When forming the easily adhesive layer, the surface on which the easily adhesive layer was formed was bonded to the barrier layer 52.

TABLE 1

| | | Base material layer(nylon film) | | | | | | | | | |
|---|---|---|---|---|---|---|---|---|---|---|---|
| | | | | | | | | | Number | | |
| | | Hot water | | | Elastic | | Breaking | | average | Evaluation | |
| | | shrinkage | | | modulus | | strength | | molecular | | Piercing |
| | | (%) | | | (GPa) | | (MPa) | | weight of | | strength |
| | Remarks | TD | MD | TD − MD | TD | MD | TD | MD | polyamide | Formability | (N) |
| Ex. 1 | ONY20 easy | 4.3 | 3.4 | 0.9 | 2.3 | 2.5 | 345 | 282 | 30,000 | ⊚ | 27.1 |
| | adhesion | | | | | | | | | | |
| Ex. 2 | ONY20 easy | 3.7 | 3.0 | 0.7 | 1.9 | 2.5 | 372 | 305 | 23,000 | ⊚ | 26.3 |
| | adhesion | | | | | | | | | | |
| Ex. 3 | ONY20 easy | 1.2 | 3.8 | 0.4 | 2.0 | 2.7 | 333 | 297 | 16,000 | ⊚ | 25.9 |
| | adhesion | | | | | | | | | | |
| Ex. 4 | ONY20 easy | 3.6 | 2.6 | 1.0 | 2.0 | 2.4 | 383 | 331 | 23,000 | ⊚ | 26.1 |
| | adhesion | | | | | | | | | | |
| Ex. 5 | ONY20 easy | 4.8 | 3.6 | 1.2 | 1.8 | 2.0 | 335 | 308 | 20,000 | ⊚ | 25.7 |
| | adhesion | | | | | | | | | | |
| Ex. 6 | No easy | 4.2 | 3.8 | 0.4 | 2.0 | 2.7 | 333 | 297 | 16,000 | ◯ | 25.9 |
| | adhesion | | | | | | | | | | |
| | of Ex. 3 | | | | | | | | | | |
| Ex. 7 | ONY15 easy | 4.5 | 3.8 | 0.7 | 2.1 | 2.5 | 356 | 299 | 21,000 | ⊚ | 24.4 |
| | adhesion | | | | | | | | | | |
| Com. Ex. 1 | ONY20 easy | 4.6 | 2.6 | 2.0 | 1.9 | 2.2 | 323 | 296 | 21,000 | X | 21.3 |
| | adhesion | | | | | | | | | | |
| Com. Ex. 2 | ONY20 | 3.7 | 2.1 | 1.6 | 1.5 | 2.0 | 303 | 281 | 18,000 | X | 18.2 |
| | No easy | | | | | | | | | | |
| | adhesion | | | | | | | | | | |

The characteristics of the nylon film as a base material layers of Example 1 are shown in Table 1. As shown in Table 1, the nylon film of Example 1 was 4.3% in the hot water shrinkage in the transverse direction TD and 3.4% in the hot water shrinkage in the machine direction MD, 0.9% in the difference (TD-MD) between the hot water shrinkage in the transverse direction TD and the hot water shrinkage in the machine direction MD, 2.3 GPa in the transverse direction TD, 2.5 GPa in the machine direction MD, 345 MPa in the breaking strength in the transverse direction TD, 282 MPa in the breaking strength in the machine direction MD, and 30,000 in the number average molecular weight of polyamide.

Note that in the remarks of Table 1, the thickness of the nylon film and the presence or absence of an easily adhesive layer are described. For example, in Example 1, “ONY20” indicates that the thickness of the nylon film was 20 μm, and “easy adhesion” indicates that an easily adhesive layer was formed.

Here, the hot water shrinkage is a dimensional change rate in the stretching direction (shrinkage direction) of a test piece (1 cm×1 cm) of a nylon film before and after being immersed in hot water at 100° C. for 5 minutes and was determined by the following equation.

Hot water shrinkage (%)={(X−Y)/X}×100
X: Dimension in the stretching direction (MD or TD) before immersion processing
Y: Dimension in the stretching direction (MD or TD) after immersion processing
Note that in this example, although the hot water shrinkage was measured using a 1 cm×1 cm test piece, the size of the test piece in the present invention is not particularly limited. For example, a test piece of an appropriate size of 1 cm to 10 cm×1 cm to 10 cm can be used.

The elastic modulus (Young's modulus) (Unit: GPa) was calculated for the core material from the “stress-strain curve (SS curve)” obtained by tensile-measuring a test piece (a test piece of a base material layer film) under the condition of the sample length 100 mm; the sample width 15 mm; the distance between scores 50 mm, and tensile speed 200 mm/minute in accordance with JIS K7127(1999). The “inclination of the tangent of the straight-line portion” in the stress-strain curve is the Young's modulus. “Strograph (AGS-5kNX)” manufactured by Shimadzu Corporation was used as a tensile test machine. The term “Young's modulus” is a synonym with Young's modulus as defined in ASTM-D-882.

The tensile breaking strength is a breaking strength (Unit: MPa) obtained by measuring under the conditions of the sample width 15 mm, the gage length 100 mm, and the tensile speed 100 mm/minute, according to a tensile test of JIS K7127-1999.

The number average molecular weight of the polyamide was determined by gel permeation chromatography (GPC).

### Examples 2 to 7

Nylon films having the properties shown in Examples 2 to 7 in Table 1 were prepared. By using the nylon films, packaging materials 1 of Examples 2 to 7 as described above were prepared. Note that in Example 6, as shown in the remarks of Table 1, a nylon film having no easily adhesive layer and the same thickness as that of Example 3 was used.

### Comparative Examples 1 and 2

Nylon films having the characteristics shown in Comparative Examples 1 and 2 of Table 1 were prepared. Packaging materials 1 of Comparative Examples 1 and 2 were prepared in the same manner as described above except that the nylon film was used.

### <Evaluation of Formability>

Deep drawing was performed on the packaging materials 1 of Examples 1 to 7 and Comparative Examples 1 and 2 using a deep drawing tool manufactured by Amada Corporation to form a recessed portion having a rectangular shape in plan view having a size of the vertical 55 mm×the horizontal 35 mm. The presence or absence of pinholes and/or cracks of the corner portion in the obtained molded product was checked to determine the “Max forming depth (mm)” in which pinholes and cracks did not occur, and evaluated based on the criteria shown below. The presence or absence of cracks or pinholes in the evaluation was examined by a light transmittance method in a dark room. Among “©,” “0,” and “X” of the evaluation criteria described below, “(” and “0” denote “Pass,” and “X” denotes “Fail.”
⊚: Forming depth of 7 mm or more without cracks or pinholes
◯: Forming depth of 5 mm or more and less than 7 mm without cracks or pinholes
X: Forming depth of less than 5 mm with cracks or pinholes

Evaluation results of formability thus obtained are evaluated in Table 1.

### <Piercing Strength Test (Piercing Resistance Evaluation)

The piercing strength is a value measured according to to JIS (Japanese Industrial Standard) Z1707: 2019. That is, the piercing strength test was measured by the following procedures (1) to (3).

(1) A test piece obtained from the packaging material 1 of each Example and each Comparative Example was fixed with a jig, and a semi-circular needle of a diameter 1.0 mm, a tip-shaped radial 0.5 mm was pierced with a test velocity 50±5 mm/min and the maximal force (N) until the needle penetrates was measured.

(2) The numbers of test pieces were 5 or more in each Example and each Comparative Example and averaged over the entire width of the test piece.

(3) In a case where the test results depend on whether it penetrates from either side of the test piece, it was performed on each side. The reported value was one decimal place.

The results of the piercing strength test thus obtained are shown in Table 1.

As can be seen from the above evaluation, the packaging materials of Examples were excellent in both formability and piercing resistance. In contrast, the packaging materials of Comparative Examples were inferior to formability and piercing resistance as compared with the packaging material of Examples.

This application claims priority to Japanese Patent Application No. 2020-208209, filed on Dec. 16, 2020, and Japanese Patent Application No. 2021-186839, filed on Nov. 17, 2021, the disclosures of which are incorporated herein by reference in its entirety.

The terms and expressions used herein are for illustration purposes only and are not used for limited interpretation, do not exclude any equivalents of the features shown and stated herein, and it should be recognized that the present invention allows various modifications within the scope of the present invention as claimed.

### INDUSTRIAL APPLICABILITY

The packaging material for a power storage device according to the present invention can be used for a power storage device, such as, e.g., a battery and a capacitor, in a mobile device or an electric vehicle.

### DESCRIPTION OF SYMBOLS

1: Packaging material
10: Power storage device main body
51: Base material layer
52: Barrier layer
53: Sealant layer

1. A packaging material for a power storage device, comprising:
a base material layer;
a barrier layer laminated on an inner side of the base material layer; and
a sealant layer laminated an inner side of the barrier layer,
wherein the base material layer is formed of a polyamide film,
wherein the base material layer is 2.0% to 5.0% in hot water shrinkage in both a transverse direction (TD) and a machine direction (MD),
wherein the base material layer is 1.5% or less in a difference between the hot water shrinkage in the transverse direction (TD) and the hot water shrinkage in the machine direction (MD),
wherein the base material layer is 1.5 GPa to 3 GPa in elastic modulus in both the transverse direction (TD) and the machine direction (MD), and
wherein the base material layer is 320 MPa or more in at least one of a breaking strength in the transverse direction (TD) and a breaking strength in the machine direction (MD).

2. The packaging material for a power storage device as recited in claim 1,
wherein the base material layer is 2.5% to 4.5% in both the hot water shrinkage in the transverse direction (TD) and the hot water shrinkage in the machine direction (MD).

3. The packaging material for a power storage device as recited in claim 1,
wherein the base material layer is 1.2% or less in a difference between the hot water shrinkage in the transverse direction (TD) and the hot water shrinkage in the machine direction (MD).

4. The packaging material for a power storage device as recited in claim 1,
wherein the base material layer is 2.0 GPa to 2.5 GPa in both elastic modulus in the transverse direction (TD) and elastic modulus in the machine direction (MD).

5. The packaging material for a power storage device as recited in claim 1,
wherein the base material layer is 400 MPa or less in at least one of a breaking strength in the transverse direction (TD) and a breaking strength in the machine direction (MD).

6. A power storage device comprising:
a power storage device main body; and
the packaging material as recited in claim 1,
wherein the power storage device main body is packaged with the packaging material.
